(19) United States
(12) Patent Application Publication
(10) Pub. No.: US 2008/0168870 A1
(43) Pub. Date: Jul. 17, 2008

(54) Adjustable Compound Cutters or Grippers

(76) Inventor: Paul E. Caravello, Greenacres, WA (US)

Correspondence Address: PAUL CARAVELLO, 5226 S. SALTESE LAKE RD., GREENACRS, WA, 99016, US

(21) Appl. No.: 11/623,263

(22) Filed: Jan. 15, 2007

(51) Int. Cl. B25B 7/16; B26B 13/26

(52) U.S. Cl. 81/321; 30/177; 81/364

(57) ABSTRACT

A cutting or gripping tool capable of producing high leverage force using compound linkage and with a wide range of motion using an adjustable rack system that forms an adjustable triangular shape without changing the compound force. The tool is designed such that it could be operated with one hand to cut a material with successive squeezing of the handles. It embodies an automatic or manual adjustment to a desired opening with linkage that amplifies the mechanical force of the handles. Its uses include but are not limited to: cutting animal hooves, pruning branches, gripping/cutting bolts and clamping objects.

### BACKGROUND OF THE INVENTION

This invention pertains to a method and tool for cutting, gripping or clamping a variety of materials.

A number of different utility tools are commercially available for a variety of cutting or gripping jobs. Many designs have been made using levers, cams and gears to compound the force exerted on the handles to the cutters or jaws of the tool, ( see referenced patent nos.). To significantly increase the force multiplication, the travel distance of the handles has to greatly surpass the travel distance of the cutters or jaws. This results in a very small usable cutting or gripping opening size compared to the handle opening size. Ratcheting type mechanisms have been devised that help alleviate this problem but they have been cumbersome and not easily released if needed. Adjustable rack systems have also been devised but as the rack adjusts, the mechanical leverage changes. Sliding fulcrums also experience the leverage change. This invention uses an adjustable rack system to change the shape of a triangle shape without changing the pivot points of the leverage system thus with no change in mechanical leverage.

### SUMMARY OF THE INVENTION

An object of this invention is to provide a new and useful method for cutting or gripping a variety of materials while also providing a mechanical advantage for leverage with a minimal effort or gripping force.

This invention has a means for compounding the leverage and closing the jaws with successive squeezing of the hand levers and instantly releasing the jaws when the handles are released enabling one hand usage. The compound force also remains relatively constant enabling a person with less grip strength to cut through or grip very hard materials.

The above and other objects and attendant advantages of the present invention will be more readily apparent to those skilled in the art from a reading of the following detailed description in conjunction with the accompanying drawings. The drawings show one preferred embodiment of the invention for illustration purpose only but not for limiting the scope of the same in any way.

### BRIEF DESCRIPTION OF THE SEVERAL VIEWS OF THE DRAWINGS

FIG. 1 identifies the parts that make up the preferred embodiment for illustrative purposes. There are front and side-views showing the holes where pivot points will be and the layers of metal in each part.

FIG. 2 shows a three dimensional view of how the parts fit together.

FIG. 3 has 3 positions to show how the tool and its components interact and move when being used.

FIG. 4 shows some ergonomic handles with straight or bypass cutters and return spring with tension arm hidden inside of handles

FIG. 5 shows how a rack system could look with two intermeshing racks for smoother adjustments.

FIGS. 6,7,8,9 show different jaws for the tool

FIG. 10 shows two alternate configurations with the rack being movable and rotating to adjust Jaw opening.

### DETAILED DESCRIPTION OF THE INVENTION

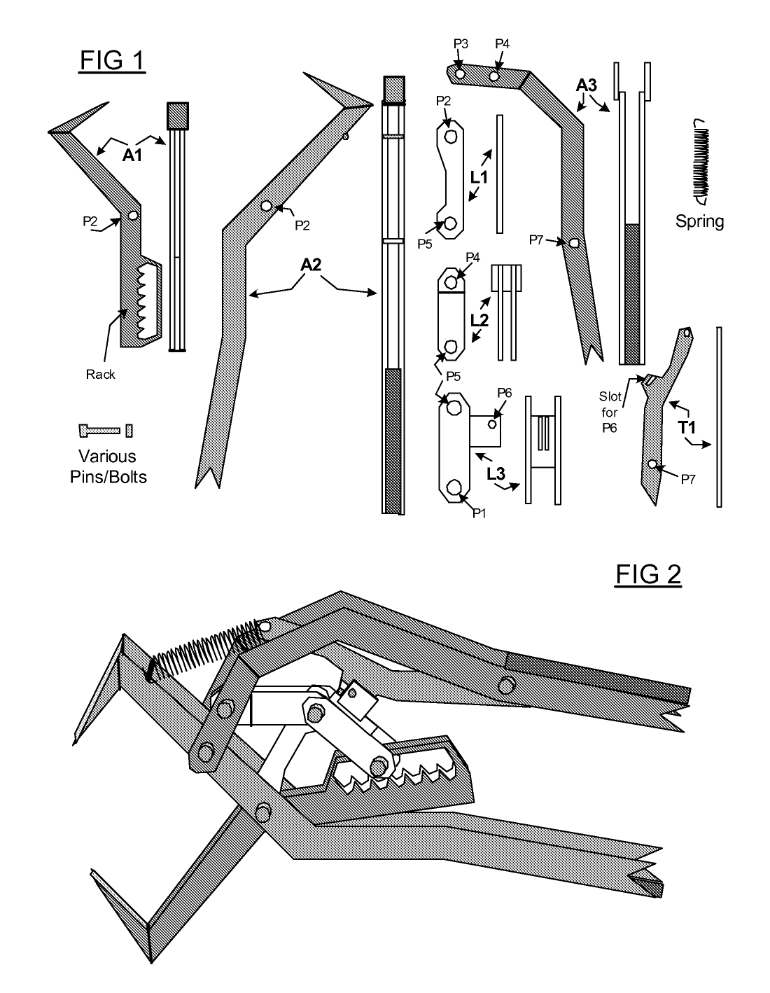

FIG. 1 shows the parts for this embodiment described as follows.
A1: One half of the jaws including pivot point P2 and Rack. Two layers of metal with an opening around pivot point P2 where Link L1 fits between the two layers of metal.
A2: One half of the Jaws including pivot point P2 and Handle. Two layers of metal with an opening around pivot point P2 where A1 fits between the two layers of metal.
L1: Single layer of metal with two holes that connect P2 and P5.
L2: Two layers of metal with added layers at one end to fit inside of A3 at P4 and the other end to allow L1 to fit inside while fitting inside of L3 at pivot point P5.
L3: Two layers of metal joined by a capping piece with two layers attached to it for the Tension Arm, T1, to interact with at pivot point P6. The two main layers are spaced such that one end encompasses L2 and L1 at P5 and the other end fits over the Rack at P1.
A3: Two layers of metal with wider opening at P3 and P4 to encompass L2 and A2.

At pivot point P7, T1 is attached inside and allowed to move in one direction but not the other because of the shape of the handle and positioning or P7.
T1: Tension Arm for automatic adjustment, a single layer of metal with a hole for the spring and pivot point P7. A slot is also provided for Pivot point P6 to attach to and slide in.

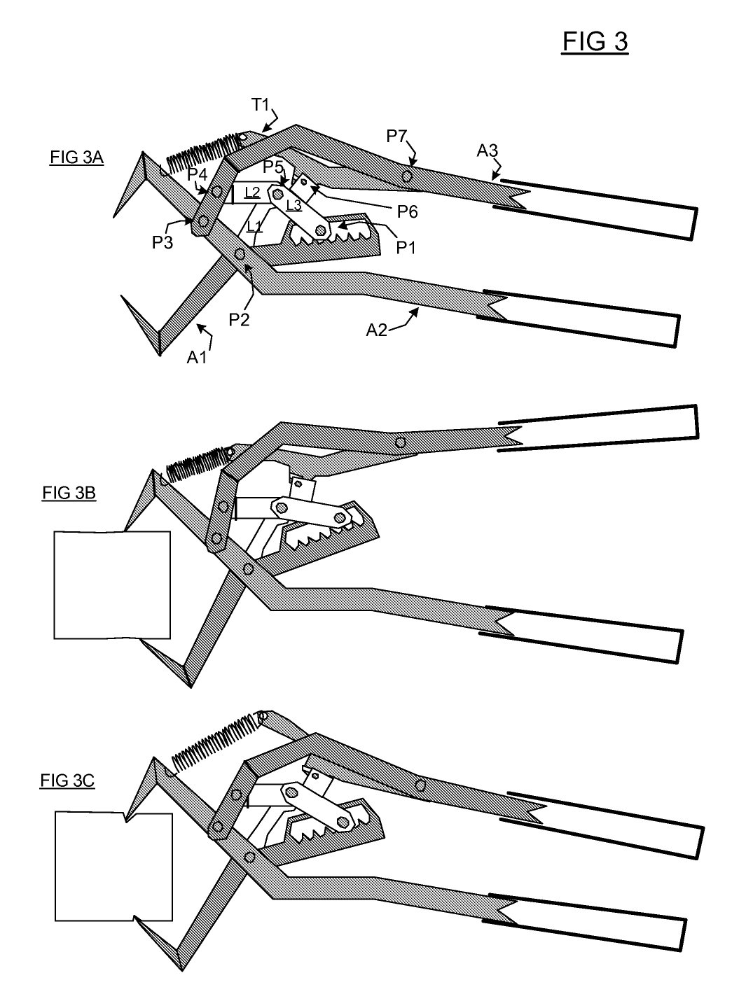

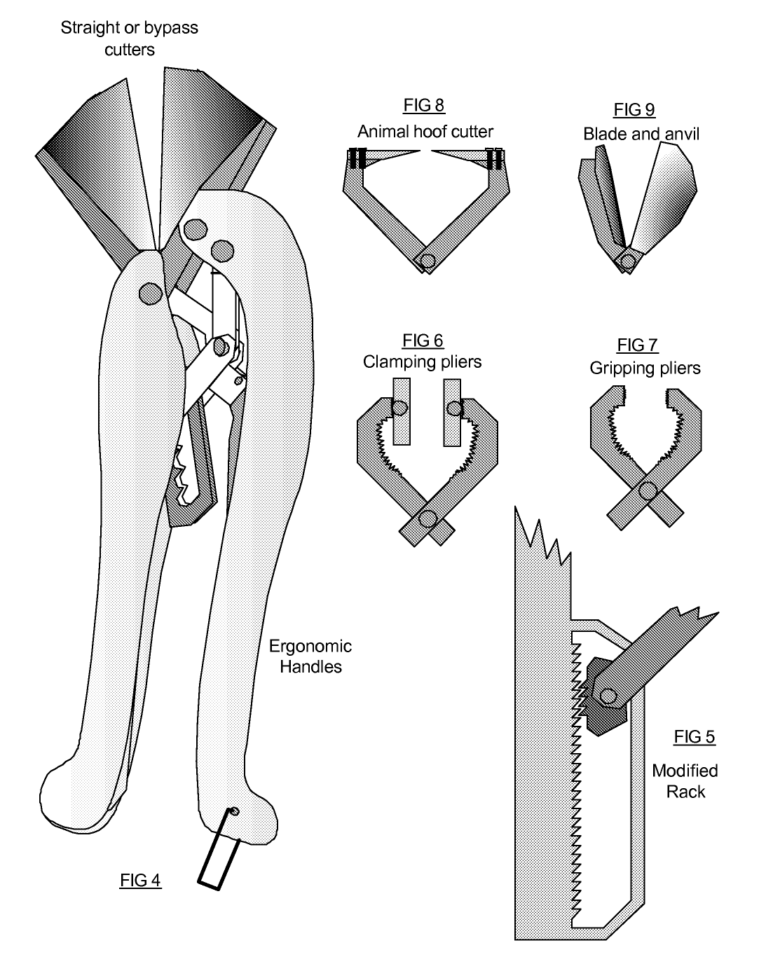

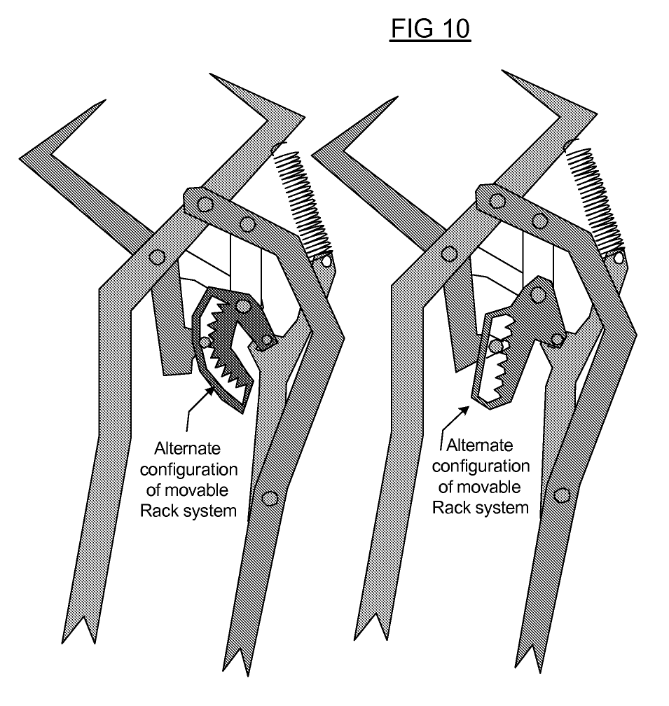

Reference FIG. 3A, from the points P1 to P2 to P5 a triangle is created that adjusts from an obtuse to an acute triangle. It is this adjusting triangle that allows a wide range of Jaw motion but retains the compound forced needed when there is resistance at the Jaws. The triangle can change shape but the mechanical compounding force remains relatively unchanged. This compound force is relational and is mostly determined by the distance between P3 to P4 compared to the distance between P2 to P5. This ratio remains constant through all motions of the tool. The compounding increases slightly as the handles are squeezed closer because the angle created by P3,P4,P5 becomes more obtuse thus increasing the mechanical leverage. In a cutting tool, this increase is available where most needed, the final stages of cutting through a material.

The Tension Arm, T1, is pivoted at point P7 inside the handle of A3 such that it can only pivot out of the assembly with tension from the spring creating a force applied to L3 to adjust to a smaller opening of the Jaws. Upon release of the handles T1 will excerpt an opening force on L3 to open the Jaws to their widest by moving P1 to the end of the Rack. This action creates the automatic adjustment for the tool.

FIG. 3 shows a typical movement of parts as the tool would be used.

Reference FIG. 3A, with no resistance to the Jaws, P1 will slide through the rack progressively closing the Jaws as the handles are closed. The spring attached to T1 applies pressure on P6 causing L3 to rotate through the steps on the Rack. Upon releasing the handles the spring causes the handles to separate, this in turn causes T1 to pull on P6 that makes L3 rotate back through the Rack opening the Jaws to their widest point.

Reference FIG. 3B, with resistance at the Jaws, P1 begins to engage with the teeth in the Rack allowing the compound force created by the linkage from points P2, P3, P4 and P5 to continue closing the Jaws.

Reference FIG. 3C, the compound force has now crimped or cut the resistance and with a slight release of the handles, L3 will rotate to make P1 engage in the next step on the Rack. The Tension Arm, T1, has been rotated back and has tension from the spring to push on P6 and L3 to cause this stepping on the Rack. Progressive squeezing action will cut through, grip or clamp the resistance material as desired.

### REFERENCED PATENTS

6,829,828
6,540,027
6,513,248
6,000,307
5,761,815
5,715,604
5,511,314
5,307,565
5,245,755
5,184,404
5,046,250
4,899,445
4,696,107
4,674,184
4,312,127
4,221,048
4,178,682
4,176,450
4,144,737
4,130,938
4,094,064
4,084,317
3,915,037
3,885,309
3,851,389
3,638,307
3,390,455
3,273,240
3,210,844
3,170,345
3,091,841
2,655,722
2,579,272
2,520,905
2,469,036
2,437,432
2,436,260
2,341,654
2,222,744
2,166,089
2,090,228
1,772,224
1,648,984
1,572,787
1,164,981
1,066,675
896,088
847,980
835,900
793,200
787,414
640,257
563,458
417,790
416,500
366,605
165,445
160,563
128,642

1. An adjustable cutting, gripping or clamping tool encompassing 3 pivot points and linkage with one movable pivot point able to move through a rack system that creates an adjustable triangular shape among said 3 points.
This shape is connected to or is part of the arm or lever that is connected to the main fulcrum of the tool with another arm or lever to push or pull on this shape to close or open the jaws of the tool.
This triangular shape will remain rigid but able to rotate around the fulcrum until the one movable pivot point is moved to another step or position on the rack.
Said rack may be curved, semicircular or straight and alternatively the movable pivot point could remain stationary and the rack could rotate to change said triangular shape.

2. The combination of claim 1 where a tool has more pivot points and linkage to one arm or lever to create a compound force at the tool jaws by closing of the handles.

3. The combination of claim 1 where a tool uses a cam or geared assembly on an arm or lever to create a compound force at the tool jaws by closing of the handles.

4. The combination of claim 1 with a tension arm connected to one handle or arm that will automatically adjust the triangular shape with the closing of the handles by moving the movable pivot point to another position on the rack or by moving a movable rack around a stationary pivot point.

5. The combination of claim 1 with a manual adjustment to the triangular shape to grip or clamp different sized objects.

6. The combination of claim 4 that the tension arm will adjust the triangular shape with the release or opening of the handles.

7. The combination of claim 6 whereas a spring is used to open the tool to full extent and to provide tension on the tension arm

8. The combination of claim 1 where the rack system uses two racks that mesh together creating a smoother adjustment where one rack is connected to or part of the lever and the other rack is connected to or part of the movable pivot point.

9. The combination of claim 1 with extension handles for two-handed operation or for extended reach applications.

10. The combination of claim 1 with formed metal or plastic for ergonomic handles and/or rubberized grips.

11. A utility tool as in previous claims to have cutters for animal hooves, grippers for pliers, clamps for a clamping tool, cutters for pruning or hard material cutting, or one blade and an anvil of different shapes for different types of material.

12. A utility tool as in previous claims to have a locking mechanism for an adjustable locking pliers or clamp with manual or automatic adjustments
